(19) United States
(12) Patent Application Publication
(10) Pub. No.: US 2026/0148660 A1
(43) Pub. Date: May 28, 2026

(54) Braille and Universal Tactile Indicia and Messaging for Aircraft Cabin Surfaces and Method

(71) Applicant: The Boeing Company, Arlington, VA (US)

(72) Inventors: Will James Roach, Seattle, WA (US); Robert Wayne Peugh, Seattle, WA (US); Zixuan Weng, Anaheim, CA (US)

(21) Appl. No.: 19/194,205

(22) Filed: Apr. 30, 2025

Related U.S. Application Data
(60) Provisional application No. 63/725,085, filed on Nov. 26, 2024.

(51) Int. Cl. G09B 21/00

(52) U.S. Cl. CPC G09B 21/003

(57) ABSTRACT

Aircraft cabin substrates comprising, in combination, visually detectable printed indicia and tactilely detectable printed indicia, with both indicia types configured to convey messaging to a both “sighted” populations of users (the visually detectable printed indicia) and a visually-challenged populations of users (the tactilely detectable printed indicia), and wherein both conveyed messaging types can be related to directional and/or instructional information wherein both conveyed messaging types can be configured to convey to a particular population an equivalent conveyed printed message.

### RELATED APPLICATIONS

This Application is a U.S. Non-Provisional Patent Application claiming benefit of priority to U.S. Provisional Application Ser. No. 63/725,085 filed Nov. 26, 2024, the entire contents of which are incorporated herein by reference in its entirety.

### TECHNOLOGICAL FIELD

The present disclosure relates generally to the field of conveying messaging and information via visually detectable and non-visually detectable methods and signage. More specifically the present disclosure relates to the field of visually detectable and non-visually detectable information distribution from fixed substrate surfaces.

### BACKGROUND

Imparting information including directional or labeling information of a location or destination to a viewer via, for example, viewable signage, can facilitate the organized and desired behavior and movement of the viewer, as a viewer is able to perceive and digest sought after information (e.g., information regarding the location of a sought after destination, etc.). In addition, signage imparting or otherwise conveying sought after directional information pertaining to a desired physical location or destination for visually challenged viewers can involve the placement of Braille or other raised or depressed indicia to impart such information.

Unless explicitly identified as such, no statement herein is admitted as prior art merely by of such statement's inclusion in the Technological Field and/or Background section.

### SUMMARY

The present disclosure is directed to visually detectable and non-visually detectable information distribution that can include regulatorily mandated and otherwise desirable informational messaging distribution from printed substrate surface features located on fixed substrate surfaces in aircraft passenger cabins.

A present aspect is directed to a substrate comprising a cured print material on a substrate surface of the substrate to form a printed substrate, with the printed substrate comprising a printed substrate first side, and with the printed substrate first side comprising a printed substrate first side surface. The printed substrate first side further comprises, in combination, a visually detectable printed indicia and a tactilely detectable printed indicia, said printed substrate first side further comprising a printed substrate first side printing area. The printed substrate further comprises a printed substrate second side, wherein the substrate comprises a substrate thickness ranging from about 5 mils to about 1000 mils, and wherein the tactilely detectable printed indicia comprises a cured print material, said cured print material deposited onto the printed substrate first side surface to a height measured from the printed substrate first side surface ranging from about 20 mils to about 1000 mils.

In another present aspect, the visually detectable printed indicia and the tactilely detectable printed indicia convey substantially equivalent information.

In another present aspect, the substrate is substantially transparent.

In another present aspect, the tactilely detectable printed indicia is substantially transparent.

In another present aspect, the tactilely detectable printed indicia comprise a Braille language character.

In another present aspect, the tactilely detectable printed indicia comprises a plurality of Braille language characters.

In another present aspect, the visually detectable printed indicia is configured to convey a visually detectable printed message to a viewer and the tactilely detectable printed indicia is configured to convey a printed Braille language message to a visually-challenged viewer.

In another present aspect, the visually detectable printed message is substantially equivalent to the printed Braille language message.

In a further present aspect, the substrate further comprises an adhesive layer immediately adjacent to substrate second surface.

In another present aspect, the adhesive layer is substantially transparent.

In another present aspect, the adhesive layer comprises a pressure-sensitive adhesive.

In a further present aspect, the adhesive layer comprises a UV-curable adhesive.

In another present aspect, the substrate is a decorative laminate material.

In another present aspect, the visually detectable indicia and the tactilely detectable indicia are both printed within the same printed substrate first side printing area.

In another present aspect the visually detectable printed indicia is located proximate to the tactilely detectable printed indicia.

Another present aspect is directed to an aircraft passenger cabin interior panel comprising a substrate comprising a cured print material on a printed substrate surface of the printed substrate, with the printed substrate comprising a substrate first surface comprising a combination of visually detectable printed indicia and tactilely detectable printed indicia and a substrate second surface, wherein the substrate is a thin film comprising a substrate thickness ranging from about 5 mils to about 1000 mils, and wherein the tactilely detectable printed indicia comprise a cured print material, said cured print material deposited onto the substrate first surface to a height measured from the substrate first surface ranging from about 20 mils to about 1000 mils.

Another present aspect is directed to an aircraft passenger cabin comprising a substrate comprising a cured print material on a printed substrate surface of the printed substrate, with the printed substrate comprising a substrate first surface comprising a combination of visually detectable printed indicia and tactilely detectable printed indicia and a substrate second surface, wherein the substrate is a thin film comprising a substrate thickness ranging from about 5 mils to about 1000 mils, and wherein the tactilely detectable printed indicia comprise a cured print material, said cured print material deposited onto the substrate first surface to a height measured from the substrate first surface ranging from about 20 mils to about 1000 mils.

Another present aspect is directed to an aircraft comprising a substrate comprising a cured print material on a printed substrate surface of the printed substrate, with the printed substrate comprising a substrate first surface comprising a combination of visually detectable printed indicia and tactilely detectable printed indicia and a substrate second surface, wherein the substrate is a thin film comprising a substrate thickness ranging from about 5 mils to about 1000 mils, and wherein the tactilely detectable printed indicia comprise a cured print material, said cured print material deposited onto the substrate first surface to a height measured from the substrate first surface ranging from about 20 mils to about 1000 mils.

Another present aspect is directed to a substrate comprising a cured print material on a printed substrate surface of the printed substrate, with the printed substrate comprising a substrate first surface comprising a tactilely detectable printed indicia, and a substrate second surface, wherein the substrate is a thin film comprising a substrate thickness ranging from about 5 mils to about 1000 mils, and wherein the tactilely detectable printed indicia comprise a print material, said print material deposited onto the substrate first surface to a height measured from the substrate first surface ranging from about 20 mils to about 1000 mils.

In another present aspect, the substrate is substantially transparent.

In another present aspect, the tactilely detectable printed indicia is substantially transparent.

In a further present aspect, the substrate first surface comprises a visually detectable pattern.

In another present aspect, the tactilely detectable indicia is substantially visually undetectable.

In another present aspect, the tactilely detectable indicia is substantially visually undetectable within the visually detectable pattern.

In another present aspect, the tactilely detectable printed indicia conveys directional information to a user contacting the tactilely detectable printed indicia.

In another present aspect, the substrate comprises an adhesive layer immediately adjacent to substrate second surface.

In another present aspect, the adhesive layer is substantially transparent.

In another present aspect, the substrate is a decorative laminate material.

Another present aspect is directed to an aircraft passenger cabin interior panel comprising a substrate comprising a cured print material on a printed substrate surface of the printed substrate, with the printed substrate comprising a substrate first surface comprising a tactilely detectable printed indicia, and a substrate second surface, wherein the substrate is a thin film comprising a substrate thickness ranging from about 5 mils to about 1000 mils, and wherein the tactilely detectable printed indicia comprise a print material, said print material deposited onto the substrate first surface to a height measured from the substrate first surface ranging from about 20 mils to about 1000 mils.

Another present aspect is directed to an aircraft passenger cabin comprising a substrate comprising a cured print material on a printed substrate surface of the printed substrate, with the printed substrate comprising a substrate first surface comprising a tactilely detectable printed indicia, and a substrate second surface, wherein the substrate is a thin film comprising a substrate thickness ranging from about 5 mils to about 1000 mils, and wherein the tactilely detectable printed indicia comprise a print material, said print material deposited onto the substrate first surface to a height measured from the substrate first surface ranging from about 20 mils to about 1000 mils.

Another present aspect is directed to an aircraft comprising a substrate comprising a cured print material on a printed substrate surface of the printed substrate, with the printed substrate comprising a substrate first surface comprising a tactilely detectable printed indicia, and a substrate second surface, wherein the substrate is a thin film comprising a substrate thickness ranging from about 5 mils to about 1000 mils, and wherein the tactilely detectable printed indicia comprise a print material, said print material deposited onto the substrate first surface to a height measured from the substrate first surface ranging from about 20 mils to about 1000 mils.

Another present aspect is directed to a method for forming a combination of visually detectable indicia and tactilely detectable indicia (referred to equivalently herein as “multimedia/perceptible indicia” and “multipurpose indicia”) onto an aircraft cabin interior panel exterior surface, with the method comprising providing a print substrate to a digital printer, with the print substrate comprising a print substrate surface, printing a curable print material onto the print substrate surface, with the curable print material configured to form a combination of a curable visually detectable indicia and a curable tactilely detectable indicia on the substrate surface. The method further comprises curing the print material to form a combination of a cured visually detectable indicia and a cured tactilely detectable indicia on the print substrate surface, and applying the print substrate to the aircraft cabin interior panel exterior surface of an aircraft cabin interior panel, and wherein the print substrate surface comprises the combination of visually detectable indicia and tactilely detectable indicia.

In another present aspect, a method further comprises UV-curing the curable print material to form the combination of the cured visually detectable indicia and the cured tactilely detectable indicia on the print substrate surface.

In another present aspect, a method further comprises depositing the curable print material onto the print substrate surface to a form the curable tactilely detectable indicia having an indicia height measured from the printing substrate surface, with the indicia height ranging from about 20 mils to about 1000 mils.

In another present aspect, a method further comprises co-curing the combination of the curable visually detectable indicia and the curable tactilely detectable indicia on the print substrate surface, and forming a co-cured visually detectable printed indicia and a co-cured tactilely detectable printed indicia on the print substrate surface.

In another present aspect, a method further comprises simultaneously printing the combination of the curable visually detectable indicia and the curable tactilely detectable indicia onto the print substrate surface.

In another present aspect, the combination of the curable visually detectable printed indicia and the curable tactilely detectable printed indicia that are printed onto the print substrate surface comprise related messages to form a related combination of printed indicia types.

Another present aspect is directed to a method for forming a tactilely detectable indicia onto an aircraft cabin interior panel (e.g., an aircraft cabin panel exterior surface), with the method comprising providing a print substrate to a digital printer, said print substrate comprising a print substrate surface, printing a print material onto the print substrate surface, with the print material configured to form a tactilely detectable indicia on the print substrate surface, applying the print substrate to an aircraft cabin interior panel exterior surface, and wherein the tactilely detectable indicia is configured to impart directional information to a passenger contacting the aircraft cabin interior panel exterior surface.

In another present aspect, a method further comprises printing a curable print material onto the print substrate surface, with the curable print material configured to form a curable tactilely detectable printed indicia on the print substrate surface, and curing the curable print material to form a cured tactilely detectable printed indicia on the print substrate surface.

In another present aspect, and according to a present method, the cured tactilely detectable indicia is configured to visually blend into (e.g., is “visually subsumed” within, etc.) an aircraft cabin interior panel exterior surface pattern.

In another present aspect, and according to a present method the cured tactilely detectable indicia is substantially visually undetectable.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is an illustration of a vehicle in the form of an aircraft, according to present aspects;

FIG. 2 is a perspective view of a plurality of printed substrates in the form of a printed substrate on an aircraft passenger cabin interior panel of an aircraft passenger cabin interior of an aircraft of the type shown, for example in FIG. 1, and showing tactilely detectable printed indicia, according to present aspects;

FIG. 3 is a perspective view of a plurality of present printed substrates, showing visually detectable printed indicia and tactilely detectable printed indicia, according to present aspects;

FIG. 4 is a view of the present printed substrate second side of the present printed substrates of the type shown in FIG. 3, and showing an adhesive layer on the substrate second side, according to present aspects;

FIG. 5 is a view from within an aircraft passenger cabin interior showing the present printed substrates in place on an aircraft passenger cabin interior of an aircraft of the type shown, for example, in FIG. 1, and according to present aspects;

FIG. 6 is a view from within an aircraft passenger cabin interior showing the present printed substrates in place on an aircraft passenger cabin interior panel of an aircraft of the type shown, for example, in FIG. 1, and according to present aspects;

FIG. 7 is a view from within an aircraft passenger cabin interior showing the regions of an aircraft passenger cabin interior panel that can comprise the present printed substrates in place on an aircraft passenger cabin interior panel of an aircraft of the type shown, for example, in FIG. 1, and according to present aspects;

FIG. 8 is an enlarged view of a region of an aircraft passenger cabin interior panel shown in FIG. 7 that can comprise the present printed substrates in place on an aircraft passenger cabin interior panel of an aircraft of the type shown, for example, in FIG. 1, and according to present aspects;

FIG. 9 is an enlarged view of a region of an aircraft passenger cabin interior panel shown in FIG. 7 that can comprise the present printed substrates in place on an aircraft passenger cabin interior panel of an aircraft of the type shown, for example, in FIG. 1, and according to present aspects;

FIG. 10A is an enlarged view of the present printed substrates comprising the combination of printed visually detectable indicia and printed tactilely detectable indicia, according to present aspects;

FIG. 10B is an enlarged view of the present printed substrates comprising the combination of printed visually detectable indicia and printed tactilely detectable indicia, according to present aspects;

FIG. 10C is an enlarged view of the present printed substrates comprising the combination of printed visually detectable indicia and printed tactilely detectable indicia, according to present aspects;

FIG. 11 is an enlarged view of the present printed substrates comprising the combination of printed visually detectable indicia and printed tactilely detectable indicia, according to present aspects;

FIG. 12 is an illustration of a monument in an aircraft passenger cabin comprising the present printed substrates comprising the combination of printed visually detectable indicia and printed tactilely detectable indicia, according to present aspects;

FIG. 13 is an enlarged view of a present printed substrate comprising a printed tactilely detectable indicia subsumed within a substrate surface pattern, according to present aspects;

FIG. 14 is an enlarged view of a present printed substrate comprising a printed tactilely detectable indicia subsumed within a substrate surface pattern, according to present aspects;

FIG. 15 is a flowchart outlining a present method, according to present aspects;

FIG. 16 is a flowchart outlining a present method, according to present aspects;

FIG. 17 is a flowchart outlining a present method, according to present aspects;

FIG. 18 is a flowchart outlining a present method, according to present aspects;

FIG. 19 is a flowchart outlining a present method, according to present aspects;

FIG. 20 is a flowchart outlining a present method, according to present aspects;

FIG. 21 is a flowchart outlining a present method, according to present aspects;

FIG. 22 is a flowchart outlining a present method, according to present aspects;

FIG. 23 is a flowchart outlining a present method, according to present aspects;

FIG. 24 is a flowchart outlining a present method, according to present aspects; and

FIG. 25 is a flowchart outlining a present method, according to present aspects.

### DETAILED DESCRIPTION

According to present aspects, the present application is directed to substrates comprising, in combination, visually detectable printed indicia and tactilely detectable printed indicia, with both indicia types configured to convey messaging to both “sighted” populations of users (the visually detectable printed indicia) and visually-challenged populations of users (the tactilely detectable printed indicia), and wherein both conveyed messaging types can be related to directional and/or instructional information wherein both conveyed messaging types can be configured to convey to a particular population an equivalent conveyed printed message. The

The present substrate can be applied to and otherwise can be incorporated into a decorative laminate that can be located in and can be located at an exterior of a panel that can be a panel incorporated into an aircraft passenger cabin interior of an aircraft, for example.

Further present aspects are directed to methods for printing a printable material (referred to equivalently herein as a “print material”) onto a substrate (referred to equivalently herein as a “print substrate” and/or a “substrate to be printed upon”) to form a printed substrate (e.g., the substrate that has been printed upon and now contains the print material) comprising the visually detectable printed indicia and with the printed substrate further comprising the tactilely detectable printed indicia. Present aspects further include substantially simultaneously printing a print material onto a substrate to substantially simultaneously form both visually detectable printed indicia (referred to equivalently herein as “visually detectable indicia”) and tactilely detectable printed indicia (referred to herein as “tactilely detectable indicia”). In one present example, the visually detectable printed indicia can also be the tactilely detectable printed indicia, and/or the two indicia types can both occupy the same substrate surface area, and/or the two indicia types can overlap at least a portion of the same substrate surface area.

According to presently disclosed methods, in one example, a print material is digitally printed onto a substrate surface of the substrate (e.g., a decorative substrate surface, etc.) to form a printed material (referred to equivalently herein as a “digitally printed material”) on the substrate surface, with the printed material configured to form a visually detectable printed indicia and a tactilely detectable printed indicia on the substrate surface. The present methods can include steps taken to prepare and otherwise treat the substrate surface to optimally accept, retain, and otherwise receive the print material onto the substrate surface.

A present method comprises providing a substrate to a digital printer, printing a print material onto a print substrate first surface (referred to equivalently herein as a “print substrate first side”), and curing the print material to form a cured print material on the print substrate first side. In one present example, a method is disclosed for digitally printing a print material onto a decorative substrate surface to form an indicia on the decorative substrate surface that can include printing a printed material on the substrate first side to form a visually detectable printed indicia and, in combination, printing a print material on the substrate first side to form a tactilely detectable printed indicia that can be located proximate to the visually detectable printed indicia. In a present aspect, the tactilely detectable indicia is configured to convey information to a user through a user physically contacting the tactilely detectable printed indicia (e.g., a user physically “touching” the tactilely detectable printed indicia), and the visually detectable indicia is configured to convey essentially the same information (e.g., the same or nearly the same information conveyed through the tactilely detectable indicia), visually, to a “sighted” observer.

In another present aspect, a method is disclosed for digitally printing onto a substrate surface (that can be decorative substrate surface that can also be a printed decorative visual image) a print material to form an indicia that can include printing a print material to form a tactilely detectable indicia that can be subsumed within a decorative visual image (e.g., a scene, etc.) with the tactilely detectable indicia configured to be substantially visually undetectable within decorative visual image, and with the tactilely detectable printed indicia configured to convey information to a user (that can be a visually-challenged user, referred to equivalently as a “visually-challenged observer”) through the physical act of such a user physically contacting the tactilely detectable indicia (e.g., with an element of a user's hand, etc.).

According to present aspects, the decorative substrate material can include a thin film and/or can itself be a thin film (e.g., a decorative laminate material layer referred to equivalently as a “declam”) that can be configured to adhere to, or otherwise be permanently or temporarily affixed to, for example, a panel that can be an aircraft passenger cabin interior panel of, for example, an aircraft monument in a passenger cabin of an aircraft. The decorative substrate material can be substantially transparent and/or the decorative substrate material can comprise at least regions that are substantially transparent. The decorative substrate material can be, and/or can comprise, for example, a decorative laminate material (e.g., a “declam”) of the type used and certified for use in an aircraft cabin interior. In one present example, the decorative laminate material can have a substrate thickness ranging from about 20 mils to about 300 mils.

The present methods can include curing a curable print material that is printed on a substrate first surface to form a printed substrate first surface (referred to equivalently herein as the “substrate first side”) according to a curing regimen that can include exposing the printed material to heat and/or exposing the printed material to ultraviolet (UV) radiation, etc. That is, according to present aspects, the print material and the printed material can be UV-curable. After curing, the curable printed material is configured to become cured printed material on the substrate surface.

According to further present aspects, the substrate comprises a substrate second surface (referred to equivalently herein as the “substrate second side). The substrate second side can comprise an adhesive layer (referred to equivalently herein as an “adhesive material layer”) that can be an adhesive film, and the adhesive layer can comprise, for example, a pressure-sensitive adhesive or other adhesive (that can be a film and/or “sheet” layer adhesive, a liquid-applied adhesive, an aerosol spray-applied adhesive, and combinations thereof, etc.), and that can form a substantially transparent adhesive layer. That is, present methods contemplate digitally printing a curable print material onto a substrate material (e.g., a decorative laminate material, a placard, etc.) that can then be affixed to panel exterior surface.

In addition, present methods further contemplate digitally printing a print material directly onto a substrate surface where the substrate surface is a panel exterior surface of a panel that can be, for example, an aircraft cabin panel of, for example, and aircraft cabin monument, with present methods further contemplating preparing and otherwise treating the panel exterior surface to optimally accept and retain the print material to be printed onto the panel exterior surface. The printed material is configured to form, on the panel exterior surface, a visually detectable indicia (referred to equivalently herein as a visually detectable printed indicia) and a tactilely detectable indicia (referred to equivalently herein as a tactilely detectable printed indicia) that can be located proximate to the visually detectable indicia. In a present aspect, the tactilely detectable indicia is configured to convey information to a user through a user physically contacting the tactilely detectable indicia, and the visually detectable indicia is configured to convey information, visually, to a “sighted” observer.

The present aircraft cabin panels can be incorporated into and otherwise can be configured to form, in whole or in part, various aircraft cabin monuments and structures including, for example, cabin class separators, inboard walls, ceilings, exterior and interior lavatory walls, storage compartment exteriors, monument walls, seat backs, seat frames, galley compartments, galley carts, etc.

The present substrates can be covering layers (e.g., decorative covering layers, etc.) incorporated into, and that can otherwise form, for example, the exterior surface coverings for various aircraft cabin monuments and structures including, for example, cabin class separators, inboard walls, ceilings, exterior and interior lavatory walls, storage compartment exteriors, monument walls, seat backs, seat frames, etc. The substrate material in the form of panel coverings, and/or the panels themselves, can further incorporate and/or otherwise can comprise a flame retardant material and/or a flame retardant material layer, and/or a flame barrier layer comprising, for example, aluminum foil, phenolic prepreg, a low heat release panel comprising aluminum, acrylic-polyvinyl chloride thermoplastic, polyvinyl chloride thermoplastic, and combinations thereof, etc. The low heat release panel can reduce a heat release rate of the panel construction in the event the panel construction is exposed to an elevated temperature and/or fire. Phenolic prepreg material can include fiberglass fabric that can be saturated with phenolic resin and B-staged at low temperature.

The substrate material in the form of panel coverings, and/or the panels themselves, can further incorporate and/or otherwise comprise a fiber resin-based material (e.g., a fiberglass material, a fiber-containing composite material, a carbon fiber-containing composite material, etc.). In addition, the substrate material in the form of panels coverings, and/or the panels themselves can further incorporate and/or otherwise comprise aluminum.

The substrate configured to accept the printed material can be and/or can comprise materials including, but not limited to, polymer films including polyvinyl fluoride (PVF), polyvinylidene fluoride (PVDF), polyvinyl chloride (PVC), acrylic-polyvinyl chloride, phenolic prepreg, fiberglass reinforced resin, carbon fiber reinforced resin, aluminum foil, fiber reinforced flame retardant epoxy, and combinations thereof.

The tactilely detectable printed indicia (referred to equivalently herein as a “printed tactilely detectable indicia”) can include a tactilely detectable textured surface. The term “tactilely detectable” is meant to refer to a “raised” state and/or raised configuration from a substrate surface that can be physically detected through contact and otherwise “felt” through physical contact of, for example elements of a human hand placed into contact with the tactilely detectable indicia. In one present example, the tactilely detectable printed indicia can form a recognizable pattern and/or universally recognized/accepted pattern that can be produced within the tactilely detectable indicia, and with the recognizable/recognized pattern and the tactilely detectable printed indicia configured to convey information to a user contacting the tactilely detectable printed indicia. According to present aspects, the tactilely detectable printed indicia can be Braille language characters that are configured to form Braille language words, phrases, sentences, etc. In one present example, the tactilely detectable printed indicia can be printed onto the substrate surface to an indicia “height” from the substrate surface ranging from about 20 mils to about 1000 mils.

Present methods for modifying and creating substrate surfaces to convey messaging obviate the onerous previous procedures that previously resulted in complex, expensive manufacturing processes that produced significant waste material, and that previously required complex tooling for molds, application of materials into molds, and/or applying molding equipment to substrates, maintenance of molded part inventory, etc. That is, the presently disclosed and improved printed substrates can be made according to present methods, while obviating previously observed processing steps including, for example, the manufacture and use of expensive individual tooling that would be required to individually shape a surface contour to convey selected messaging.

In addition, previous non-digital “printing” methods involved wasteful multi-step printing of films including screen printing, lamination, thermal embossing, etc., that often produced laminate panels that required separate and/or repeated certification for use in, for example, aircraft and/or other vehicles. In strong contrast to previous methods, present methods, and present decorative substrates made according to such present methods, greatly simplify and significantly economize custom manufacturing processes for the present substrate surfaces and present panels comprising the present substrates by using, for example, a curable digital print material to “build” substantially simultaneously (e.g., “print”) both: 1) textured (e.g., three-dimensional and tactilely detectable); and 2) two-dimensional and three-dimensional visually detectable indicia and images, including conveyable messaging, directly and substantially simultaneously onto a selected substrate surface incorporated, for example, into an aircraft passenger cabin interior panel.

According to a present aspect, the term “substantially simultaneously” refers to one quantity of time that is “nearly identical to” or “nearly simultaneous with” another quantity of time taken to complete a function. In one present aspect, the visually detectable printed indicia can be thinner that the tactilely detectable printed indicia; with the printing of both indicia types onto the substrate commencing and/or occurring at the same time, even though the completion of printing the tactilely detectable printed indicia onto the substrate may take longer (e.g., taking up to about one or more minutes longer that the printing of the visually detectable printed indicia, etc.).

In one example, present methods contemplate modifying and programming a commercially available machine to digitally print a textured image, message to be conveyed, etc. (referred to collectively herein as an “indicia”), either directly onto an aircraft cabin interior panel or onto a surface of a substrate that is configured to decoratively and/or functionally “cover” and/or otherwise be applied to cover an aircraft cabin interior panel (e.g., a decorative laminate covering, referred to equivalently as a “declam”, etc.), and that, as mentioned herein, obviates the use of complex manufacturing processes and attending equipment (e.g., molding equipment, molds, embossing equipment, etc.). Present printed substrate surfaces comprise tactile decorative and/or messaging information (indicia) that are made using inkjet printing and that are otherwise additively manufactured using curable print material to form textured and/or raised printing on aircraft passenger cabin interior panels that further can be incorporated into aircraft cabin structures at selected location in an aircraft cabin interior of an aircraft.

The presently disclosed use of digital printing to produce printed substrates that convey selected messaging on aircraft cabin interiors provides the ability to provide customized design, color scheme, tandem visual and tactile messaging that aligns the messaging function of the printed tactilely detectable messaging with the associated printed visually detectable messaging and, if desired with additional visually detectable imagery (e.g., designs, motifs, etc.).

Commercially available additive manufacturing printing systems including, but not limited to. printing systems comprising UV-curable print materials (e.g., UV-curable “inks”) can be used to print both a tactilely detectable indicia (e.g., textured image, etc.) and/or tactile message, and a complementary and/or equivalent visually detectable indicia and/or visual messaging image printed directly onto a panel surface and/or printed directly onto a substrate surface that can be post-applied to a panel exterior surface to form a printed panel laminate, with the printed substrate surface then becoming the most “exterior” surface of the panel, for example.

The present printed substrates produced according to the present methods provide a certified decorative substrate surface from certified materials with textured (tactilely detectable features and regions that can be “raised” features from the substrate surface including Braille language messages and/or Braille message segments), and that can further include decorative imagery information and/or conveyed messaging information, directional information, etc., that is equivalent to and/or that can otherwise “match” the visually detectable indicia messaging. Both indicia types can convey branding, decoration, messaging (e.g., including safety messaging information, warning messaging information, directional messaging information, facility location messaging, etc.).

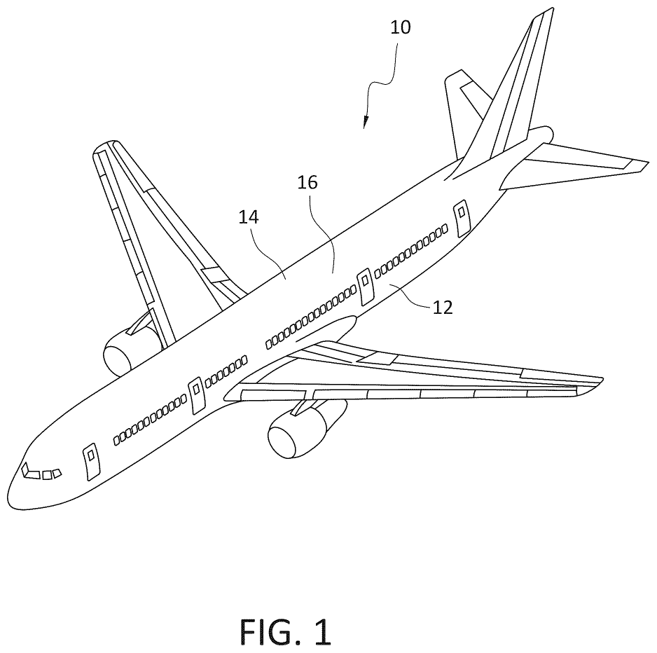

FIG. 1 is an illustration of a vehicle in the form of an aircraft 10 comprising a fuselage 12 and an internal passenger cabin 14 substantially bounded by fuselage 12 that can comprise structural component surfaces in the aircraft passenger cabin interior 16 that can comprise the present printed substrates, including monument walls, lavatory walls, ceiling, seat backs, seat exteriors, outboard walls, galley carts, galley component surfaces, etc.

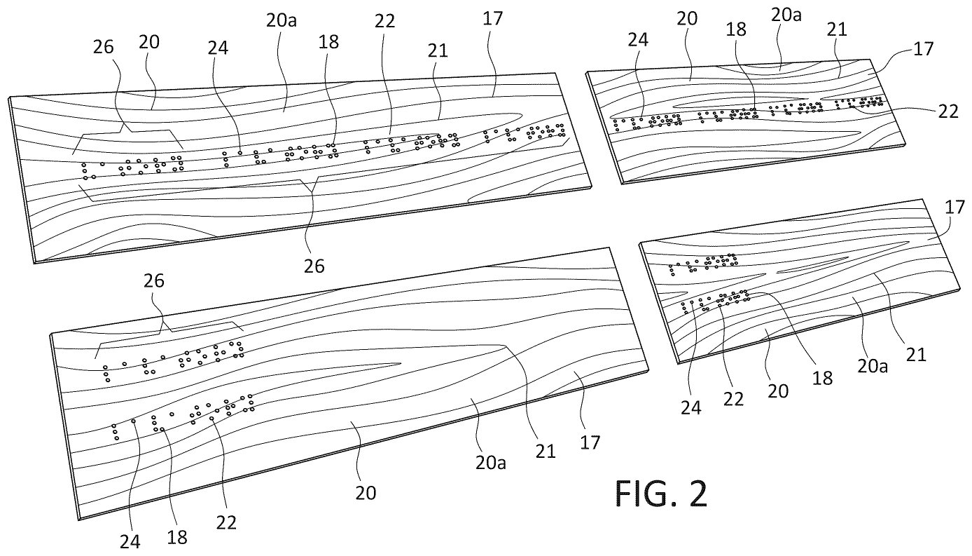

According to a present aspect, FIG. 2 is an illustration of a plurality of printed substrates 20 comprising a substrate 17 onto which is printed a cured print material 18 to form a printed substrate 20 having a printed substrate first side 20a and a printed substrate second side 20b (not visible in the view of the printed substrates shown in FIG. 2). The printed substrate first sides 20a, as shown in FIG. 2, comprises the cured printed material 18 deposited onto the printed substrate first side 20a to form a raised printed pattern that forms a tactilely detectable (printed) indicia 22. As shown in FIG. 2, the tactilely detectable indicia 22 comprises a plurality of Braille language characters 24 that, taken together, are configured to form a Braille language word and/or message 26 that can be conveyed to a Braille language user contacting the tactilely detectable indicia. The substrate 17 (onto which has been printed the cured printed material 18 applied as a curable print material that has then been cured to form the printed substrate 20) can be a thin film that can be treated or otherwise prepared to receive the curable printed material (that is then cured). In one example, the thin film substrate can have a thickness “t” ranging from about 5 mils to about 500 mils.

FIG. 2 further shows the printed substrate having a substrate design 21 that can be integrated throughout the thickness of the substrate, and/or that can occur at the substrate surface. In addition, the substrate 17 shown in FIG. 2 can be presented to a digital printer with the surface design already present. In another present example, the design can also be printed onto the substrate by, for example the digital printer, with the design also comprising printed material that has been cured or that can be cured substantially simultaneously with the curing of the printed material that forms the tactilely detectable indicia that is formed in FIG. 2 to become a Braille language message 26 formed by Braille language characters 24.

That is, according to present aspects, the substrate material can be, for example, a decorative laminate material having no design that is then altered and printed upon, according to present methods, to display, after printing, both a selected design and a tactilely detectable indicia that can convey a message to a visually-challenged individual that engages the tactilely detectable printed indicia, for example, via “touch”. The tactilely detected indicia can, if presenting a message in, for example, Braille, convey information and messaging to such an individual. Since the starting material for the substrate may have no inherent starting “design”, the present printed substrates and methods allow a starting material to only perhaps have a particular base color, with all visual designs added to the base material via printing, according to present aspects.

Present methods and printed substrates obviate the need that previously existed to stock or otherwise inventory a large variety of decorative laminate (e.g., declam) supply sheets that comprise, for example, “scenes” or “design motifs”. Instead, according to present aspects, the decorative laminates can be provided to a manufacturing point of use (e.g., an installation location, panel assembly location, finishing location, etc.) with the substrate material having only, perhaps, a base color, etc. The finished design and detail can then be added on the decorative laminate (including, for example, desired messaging) via digital printing and provided to the substrate in the form of curable print material that is then cured to form cured printed material such that the substrate can be visually customized and/or textured individually and varied, on demand, for delivery to an end-use customer, for example.

In one example, the Braille characters printed onto the substrate can have a “height” (“h”) ranging from about 20 mils to about 1000 mils. The thickness of an additional selected design formed by deposited printed material can be the same or different thickness than the thickness, or “height” (“h”) of the Braille characters. That is, as shown in FIG. 2, although not labelled as such, both the printed Braille characters and the printed surface design can be tactilely detectable features. In another present example, the printed Braille character alone can be tactilely detectable. The printed substrates 20 shown in FIG. 2 can be a thin film or a placard that can be incorporated into or applied to a panel. In one example, the placard can have a thickness ranging from about 500 to about 1000 mils. In addition, the printed substrates 20 shown in FIG. 2 can be a panel itself, with the print material 18 printed directly onto the substrate 17 that is in the form of a panel (e.g., a panel used to form an aircraft cabin interior monument, etc.).

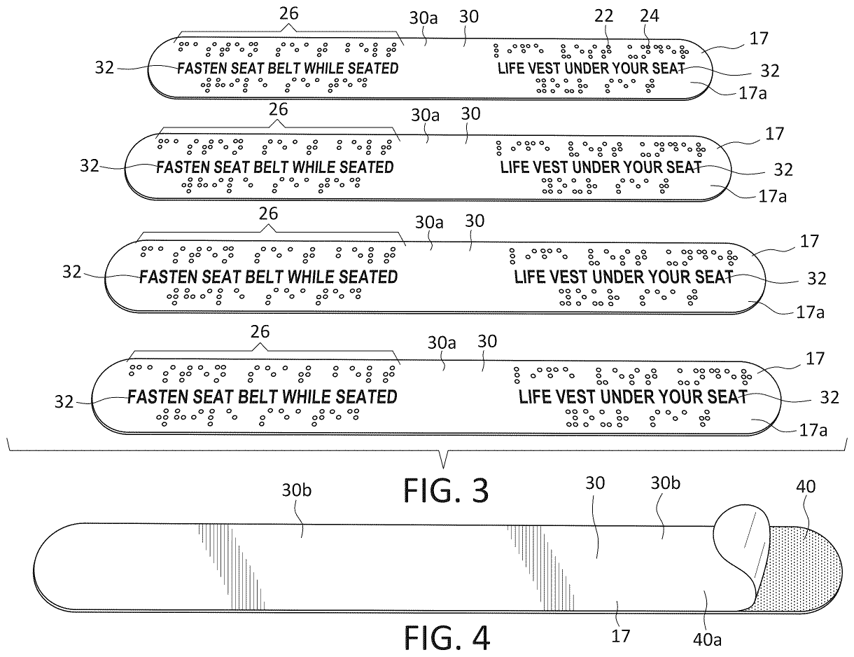

According to a present aspect, FIG. 3 shows a plurality of printed substrates 30 that, as shown in FIG. 3, can differ from one another in area, or “dimension”. The printed substrate 30 can comprise a substrate 17 that is shown as a thin film that can have a thickness ranging from about 5 mils to about 500 mils. In another present example the printed substrate 30 can comprise a substrate 17 that can be a decorative laminate material that can be a thin film that can have a thickness ranging from about 20 mils to about 300 mils. In another present example, a substrate 17 can be a thicker “placard” that can have a thickness ranging from about 500 mils to about 1000 mils. In addition, substrate 17 includes a cured print material 18 printed onto the substrate surface to form a printed substrate 30 having a printed substrate first side 30a and a printed substrate second side 30b (not visible in the view of the printed substrates shown in FIG. 3}.

The printed substrate first sides 30a, as shown in FIG. 3, comprise the cured printed material 18 deposited onto the substrate first side 30a to form a raised pattern that forms a tactilely detectable indicia 22. As shown in FIG. 3, the tactilely detectable indicia 22 can comprise a plurality of Braille language printed characters 24 that can be printed to a “height” from the substrate surface ranging from about 20 mils to about 1000 mils. The Braille language printed characters taken together, are configured to form a Braille language message 26 that can be conveyed to a Braille language user contacting the tactilely detectable printed indicia. The substrate 17 (onto which is printed the cured printed material 18 to for the printed substrate 20) can be a thin film or a thicker substrate “placard” that can be treated or otherwise prepared to receive and retain the printed material (that is then cured).

Additionally, as shown in FIG. 3, the printed substrate first side 30a of the printed substrates further comprise visually detectable indicia 32 forming visual messaging to be visually conveyed to a “sighted”, or “seeing” observer, with the visually detectable indicia 32 also formed on the substrate first side 30a by printing a curable print material onto the substrate first side 30a that is then cured to form the cured print material 18 on the printed substrate. That is, the printed substrates 30 shown in FIG. 3 comprise both a printed tactilely detectable indicia 22 and a printed visually detectable indicia 32 that can convey equivalent messaging.

In a present example, the tactilely detectable indicia can be “raised” or “built up” via, for example, additively manufactured digital printing to a print material height, “h” ranging, according to a present example, from about 20 mils to about 1000 mils. In a present example, the tactilely detectable indicia can comprise a printed material that is substantially transparent, with the tactilely detectable indicia 32 configured to be visually unobtrusive, and with the tactilely detectable indicia 32 being barely noticeable and/or substantially visually undetectable to a sighted individual.

FIG. 4 shows a substrate 17 that can be a printed substrate 30 of the type shown in FIG. 3, with FIG. 4 showing the reverse side of a printed substrate 30 of the type shown in FIG. 3, and showing the printed substrate second side 30b. Substrate second side 30b, as shown in FIG. 4, can comprise an adhesive layer 40 positioned immediately adjacent to substrate 17, and is shown having a protective and removable (e.g., peelable, etc.) adhesive backing material 40a immediately adjacent to the adhesive layer 40. FIG. 4 shows a portion of the adhesive layer backing material 40a “peeled away” from the adhesive layer 40 to partially expose the adhesive layer 40.

As stated herein, the printed substrates of the present disclosure can, according to present aspects, be configured to adorn, and can otherwise be affixed to, structures found at locations within an aircraft passenger cabin interior of an aircraft; for example, an aircraft 10 of the type shown in FIG. 1. As also mentioned herein, the printed substrates of the type shown at least in FIGS. 2 and 3 can be a thin film or cab be a thicker placard-type signage that can be incorporated into or otherwise fixedly and/or removably applied to a panel. In addition, the printed substrates 20, 30 shown at least in FIGS. 2 and 3 can be a decorative or structural panel itself (e.g., a cabin monument structural component), with the print material 18 printed directly onto the substrate that is in the form of a panel that can be incorporated into, or that can be itself configured to form, an aircraft cabin structure exterior surface (e.g., a monument, a monument wall, an inboard cabin wall, a separator wall, a storage bin, a ceiling, a seat, a seat component, an arm rest, etc.).

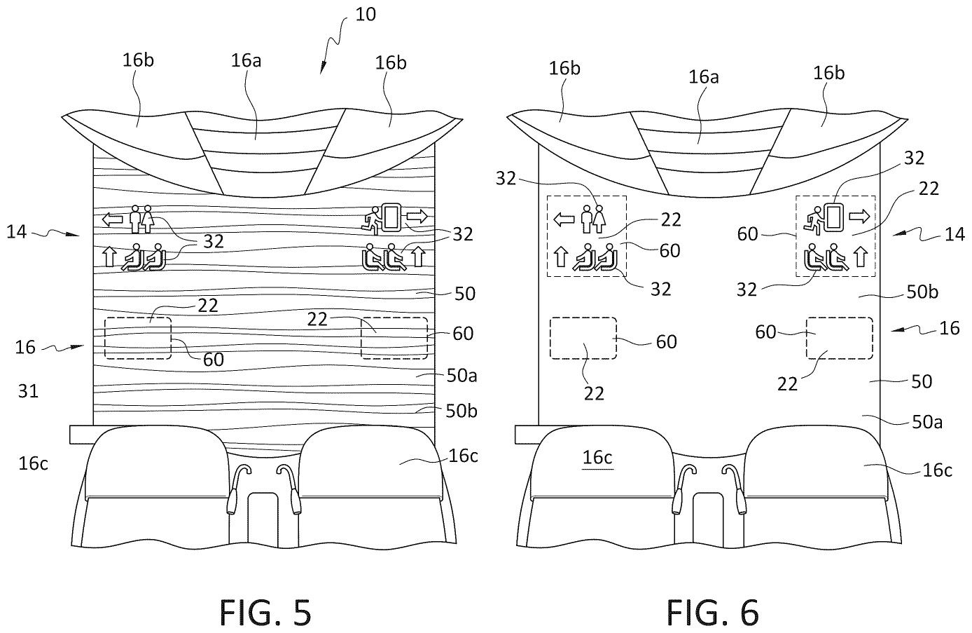

FIGS. 5 and 6 are partial representative views of an aircraft passenger cabin separator wall (referred to equivalently herein as the “cabin separator wall”) of the type that can be oriented substantially perpendicular to the longitudinal axis of an aircraft fuselage (and that can be oriented substantially perpendicular to the longitudinal axis of an aircraft cabin aisle), and that can be a structural component of an aircraft passenger cabin monument. While the view shown in FIGS. 5 and 6 may be an “aftward” view from a viewing position within the passenger cabin (e.g., looking/viewing toward the rear of the aircraft), the positioning and viewing direction of any illustrated component within the cabin is non-limiting as is the placement of indicia on the cabin component. That is, according to present aspects, the present printed substrates can be placed and/or can be adhered to, and/or can be integral with any selected aircraft passenger cabin component surface where useful information dissemination and need for message “conveying” to passengers is desirable.

Accordingly, while the printed substrates shown in FIGS. 5 and 6 pertain to the printed substrate location on or in communication with a cabin separator wall, present aspects contemplate the incorporation of the present printed substrates into aircraft cabin components and structures including, for example, cabin class separators, inboard walls, ceilings, exterior and interior lavatory walls, storage compartment exteriors, monument walls, seat backs, seat frames, and combinations thereof, etc.

FIGS. 5 and 6 show a passenger cabin interior 16 of a passenger cabin 14 that can be a passenger cabin of an aircraft 10 of the type shown, for example, in FIG. 1, with the passenger cabin 14 comprising a ceiling 16a, and with adjacently positioned storage compartments 16b located “inboard” of the ceiling 16a. Passenger seats 16c are shown with seat backs positioned proximate to cabin separator wall 50 that comprises separator wall first side 50a that comprises the present printed substrates 30 that can be, for example a decorative laminate applied to a panel, the panel itself, and/or a placard and/or “sticker” adhered to the decorative laminate and/or the panel itself. FIGS. 5 and 6 afford substantially similar views of a substantially similar aircraft passenger cabin interior, with similarly numbered components and structures shown throughout.

FIGS. 5 and 6 further illustrate a tactile messaging region 60 within which tactilely detectable indicia 22 can contain tactilely detectable information that can correspond to, can be equivalent to, and/or can be informationally additive to information that is conveyed visually from a visually detectable indicia 32 to, and received visually (e.g., perceived, etc.) by, a sighted individual. As shown in FIGS. 5 and 6, a tactilely detectable indicia 22 can be printed with a curable print material that forms a cured print material that is substantially transparent. That is, although not specifically visible in FIGS. 5 and 6, the tactilely detectable indicia 22 can be substantially transparent and can be located within the tactile messaging region 60 such that the tactilely detectable indicia is configured to be visually unobtrusive, visually undetectable, and/or substantially visually undetectable, including being substantially visually undetectable from a selected distance from the printed substrate.

FIGS. 5 and 6 illustrate a substantially similar view of a substantially similar aircraft passenger cabin interior, with components and structures in FIGS. 5 and 6 numbered similarly. FIGS. 5 and 6 differ from one another in that FIG. 5 further illustrates that decorative laminate 50b on cabin separator wall first side 50a can comprise a substrate surface design 31, or “motif”, as opposed to a separator wall first side as shown in FIG. 6 that lacks the presence of a themed or aesthetic motif, scenic theme, design, etc. In addition, FIG. 6 illustrates positioning of the tactile messaging region 60 that can be coincident with, or that can be configured to at least partially overlap, a visually detectable indicia 32.

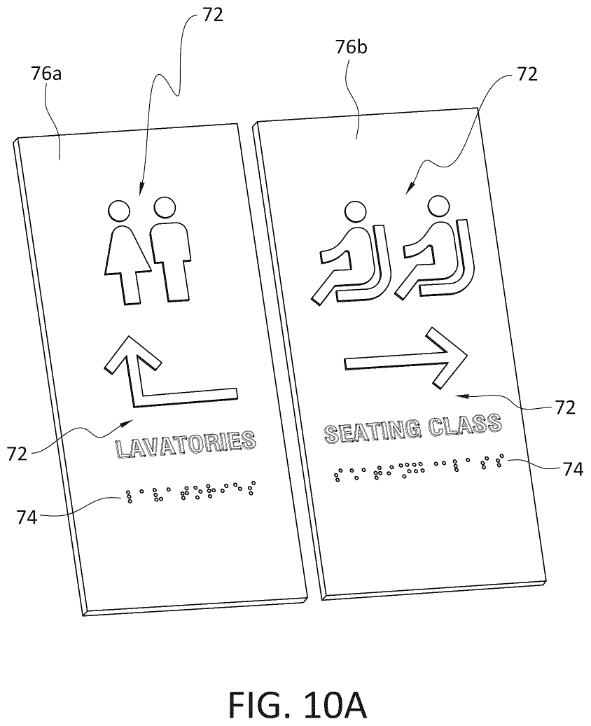

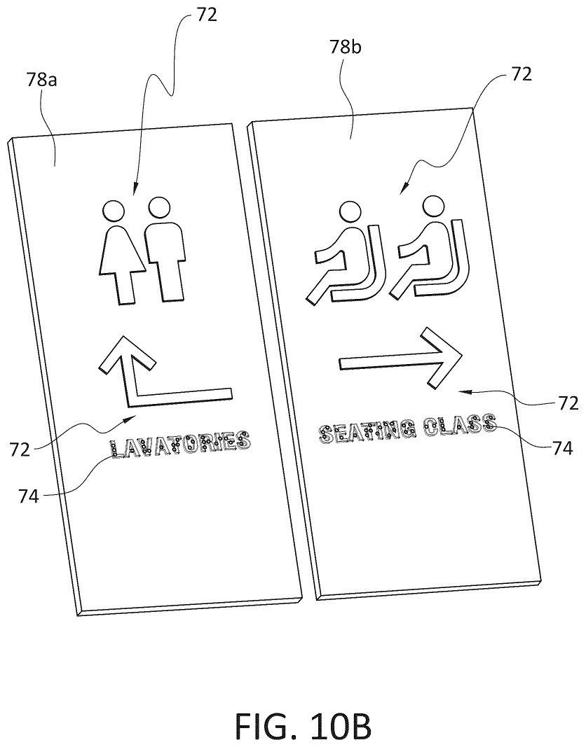

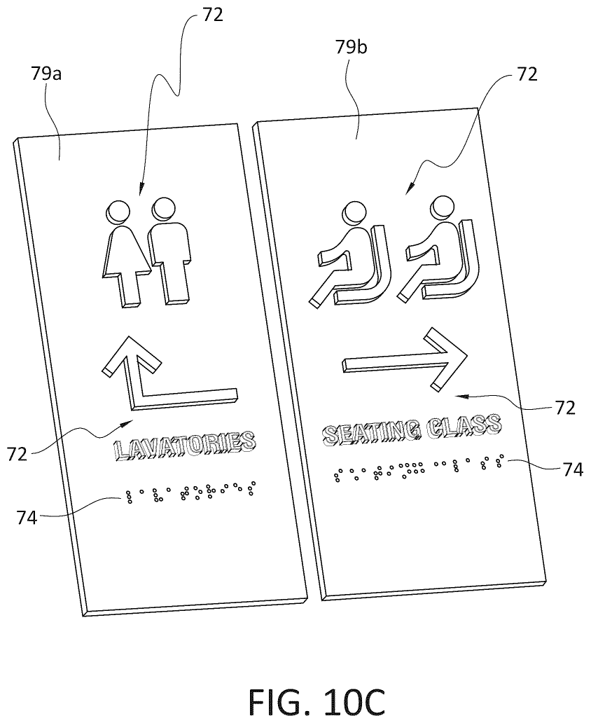

While the tactile messaging region 60 is illustrated in FIG. 5 as being proximate to the visually detectable indicia 32, the tactile messaging region 60 can also be located immediately proximate to (e.g., immediately adjacent to, and/or adjoining) the visually detectable indicia. In another present example, as explained herein, the messaging region 60 containing the tactilely detectable indicia 22 can be substantially coincident with and/or can at least partially overlap the visually detectable indicia 32. That is, according to a present aspect, a substrate can receive a print material to form a printed visually detectable indicia on a printed substrate, followed by further printing on the printed substrate to form the tactilely detectable indicia directly on the visually detectable indicia. See, for example, at least FIG. 10B.

Present aspects also contemplate the tactile messaging region containing both printed visually detectable and printed tactilely detectable indicia, with the printed tactilely detectable indicia subsumed partially or entirely within the area occupied by the printed visually detectable indicia. In one present example, and according to present aspects, at least for the purpose of blending in and not interfering with the aesthetics of the visually detectable indicia, the two printed indicia types (visual and tactile) can be printed using different print materials; with the printed tactilely detectable indicia formed from a substantially transparent cured print material.

According to present aspects, the printed substrates can comprise multiple printed indicia types (e.g., multiple indicia types to include visually detectable indicia and tactilely detectable indicia) configured to convey messaging that can include, for example, information related to directional information, location identification information, safety information, branding information, aesthetic design information, monument content information, etc. According to present aspects, the printed indicia types can be printed onto the substrate surface at proximate, coincident, and/or at least partially overlapping locations on a substrate. In one present example, the tactilely detectable indicia can be printed to complement an existing or printed design on the substrate.

In addition, as mentioned herein, the printed tactilely detectable indicia can comprise a cured print material that is transparent or substantially transparent, with the printed tactilely detectable indicia being substantially visually undetectable. “Substantially transparent” means that a minimal amount of light diffraction and/or light refraction occurs in the tactilely detectable indicia, such that virtually no visual detection of the printed tactilely detectable indicia occurs when viewing the printed tactilely detectable indicia at a distance including, for example, a distance of from more than about 2 feet from the substrate surface.

In another present aspect, the print material selected for the tactilely detectable indicia comprises a pantone configured to match the substrate location of the printed tactilely detectable indicia, making the tactilely detectable indicia difficult to visually perceive or otherwise visually separately discern (e.g., is substantially visually undetectable) on the substrate surface. That is, according to present aspects, in one example, the printed tactilely detectable indicia is printed onto the substrate surface to form a tactile indicia that is configured to visually blend into and otherwise not disturb the visual aesthetics of the substrate surface and the panel comprising the substrate surface when the substrate is, for example, a decorative laminate to be applied to, for example, a panel in an aircraft passenger cabin.

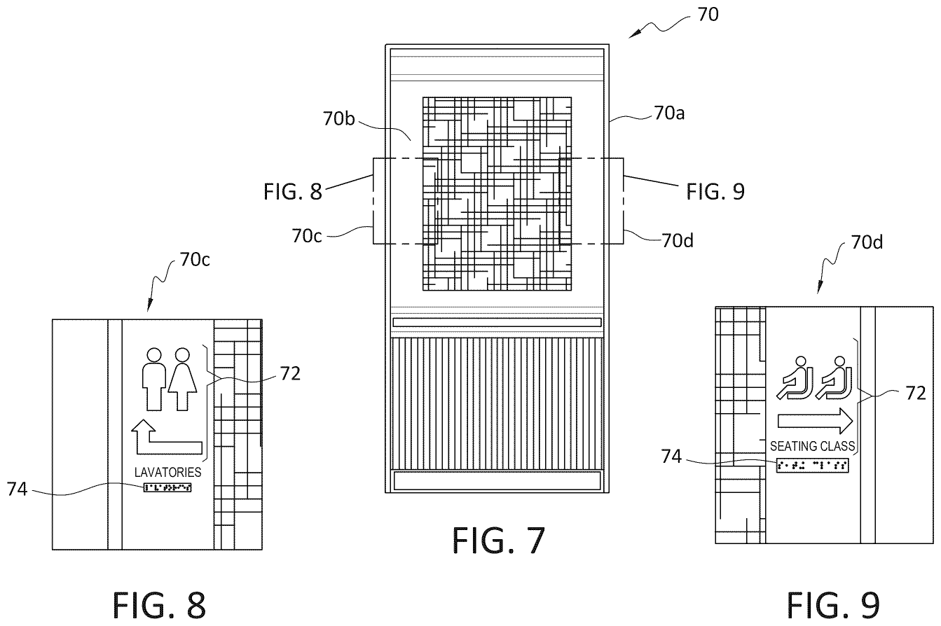

FIG. 7 is a view of an exterior surface of an aircraft passenger cabin structure in the form of a monument wall of an aircraft cabin monument of the type where the monument wall that can be, for example, located adjacent an aisle of an aircraft passenger cabin. FIGS. 8 and 9 each illustrate enlarged views of a different region of the monument wall shown in FIG. 7, with the monument wall regions comprising printed indicia on the monument wall, and with the printed indicia configured to impart visual and tactilely detectable directional information that can inform passengers as to the location of a defined destination within an aircraft. to passengers that may be located remotely from or at least a short distance away from the messaged information.

FIG. 7 shows an aircraft passenger cabin interior monument wall 70a, that can be, for example, an aircraft passenger cabin interior monument end wall of an aircraft passenger cabin monument 70 (referred to equivalently herein as a “monument”). According to present aspects, an aircraft cabin monument can be a cabin structure including, for example, a lavatory, a storage closet, a galley wall, an inboard cabin separator wall, etc. In one example, the aircraft passenger cabin monument wall can comprise a structural panel having a substrate exterior that can be a substrate onto which indicia can be directly printed, according to present aspects.

In addition, the aircraft passenger cabin interior monument wall can comprise a structural panel comprising a decorative laminate layer forming the panel's exterior layer (e.g., panel exterior surface layer) that can the substrate surface onto which indicia can be printed, according to present aspects. In another example, the aircraft passenger cabin interior monument wall can comprise a structural panel comprising an affixed placard and/or “sticker” on the panel to form the panel exterior surface that can be considered to be the substrate onto which indicia can be directly printed, according to present aspects. In a further example, the aircraft passenger cabin interior monument wall can comprise a structural panel comprising a decorative laminate layer forming the panel's exterior layer that can further comprise an affixed placard and/or “sticker” on the decorative laminate layer that can be considered the substrate onto which indicia can be directly printed, according to present aspects.

For purposes of explanation in describing at least the present FIGS. 7, 8, 9, depending upon the layers present on the monument wall, the substrate surface is understood to be the exterior surface of the outermost material or “outermost layer” present in the monument wall panel (that may or may not comprise each of a decorative laminate layer covering the panel, and/or a separate placard/sticker affixed to the panel, and/or a separate placard/sticker affixed to the decorative laminate layer). That is according to present aspects, the substrate exterior surface refers to the exterior surface of the monument wall, with the exterior surface potentially comprising at least one the structural panel, the decorative laminate layer, and the placard that can be a thin film “sticker”. On one present example, the placard and/or the decorative laminate can be a thin film that can be a flexible film having a thickness ranging from about 5 mils to about 500 mils. In another present example, the placard and/or sticker can be a thicker, inflexible material having a thickness ranging from about 500 mils to about 1000 mils, and can be affixed (e.g., adhesively affixed, removably affixed, etc.) to the panel or to the decorative laminate layer covering the panel.

FIG. 7 shows a monument wall 70a of a monument 70, with the monument wall that can be positioned in an aircraft cabin parallel to the longitudinal axis of an aircraft (and parallel to the longitudinal axis of a main aircraft cabin aisle), for example. The monument wall 70a comprises a monument wall substrate surface 70b (e.g., the exterior surface) comprising two informational printed regions: 1) a “forward” printed substrate region 70c; and 2) an “aft” printed substrate region 70d, with each region configured to provide messaging information in the form of printed visually detectable indicia information and printed tactilely detectable indicia information to a passenger, and with the printed information being directional information designed to “guide” and/or “direct” both a sighted and a visually-challenged passenger from the monument location to a defined destination located a distance away from and in the direction indicated by the directional information (e.g., either “forward” or “aft”). The “forward” designation refers to an area from the monument that is toward the forward or front section of, for example, an aircraft. The “aft” designation refers to an area from the monument that is toward the aft or rear section of, for example, an aircraft.

FIG. 8 is an enlarged view of the “forward” printed substrate region 70c of the substrate surface 70b of the monument wall 70a shown in FIG. 7. FIG. 9 is an enlarged view of the “aft” printed substrate region 70d of the substrate surface 70b of the monument wall 70a shown in FIG. 7. Printed substrate regions 70c and 70d comprise printed visually detectable indicia 72 and printed tactilely detectable indicia 74 with both indicia types (visual and tactile) configured to convey a similar information message to a passenger. As mentioned herein, the printed regions can be printed on a substrate to form a printed substrate that can be the structural panel of, for example, a monument wall, a decorative laminate covering the structural panel, and/or a placard affixed to the panel or affixed to the decorative laminate.

FIGS. 10A, 10B, and 10C show a printed substrate comprising printed indicia, with the printed substrate being a separate placard or “sticker” that can be affixed directly to a structural panel or to a decorative laminate material layer covering a panel of a monument of the type shown in FIGS. 7, 8, 9. When the printed substrate is a separate element that is then incorporated into the structural panel of, for example, a monument wall, the printed substrate can occupy and become “forward” and “aft” printed substrate regions 70c, 70d shown in FIGS. 7, 8, and 9.

FIGS. 10A, 10B, and 10C illustrate the printed substrates in the form of separate elements shown as printed substrate placards in the form of forward printed substrate region placard 76a and aft printed substrate region placard 76b that can be configured to occupy, for example, selected substrate regions of a monument wall of the type shown in FIGS. 7, 8, 9. The forward printed substrate region and the placard 76a and the aft printed substrate region placard 76b shown FIG. 10A each comprise printed visually detectable indicia 72 and printed tactilely detectable indicia 74 configured to convey visual and tactile information, respectively, to a passenger, and with the printed information imparted being directional information designed to “guide” and/or “direct” a passenger from the monument location to a defined destination located a distance away from and toward the direction indicated by the directional information (e.g., “forward” or “aft” of the monument).

In a present example, as mentioned herein, a substrate can receive a print material to form a printed visually detectable indicia on a printed substrate, and further printing on the printed substrate to form the tactilely detectable indicia directly on the visually detectable indicia. FIG. 10B illustrates placards 78a, 78b that are similar to the type shown in FIG. 10A, and differing from placards 76a, 76b by comprising both visually detectable indicia 72 and tactilely detectable indicia 74 occupying an overlapping or coincident messaging region, with, for example, the tactilely detectable indicia subsumed partially or entirely within the visually detectable indicia. As mentioned herein, according to present aspects, at least for the purpose of blending in and not interfering with the aesthetics of the visually detectable indicia, the two indicia types (visual and tactile) can be printed using different print materials, with, for example, the tactilely detectable indicia formed from a substantially transparent cured print material, such that the tactilely detectable indicia will be visually unobtrusive, substantially visually indistinct from, (e.g., visually undetectable, at least from a selected distance) the visually detectable indicia. In one present aspect, the Braille tactilely detectable indicia can be subsumed within and otherwise at least partially contained within the region also occupied by the visually detectable indicia.

Through additive manufacturing, and according to present aspects, curable print material can be printed onto a substrate surface (and then cured) to form an indicia that can serve both functions of the visually detectable indicia and the tactilely detectable indicia (referred to equivalently herein as “multi-purpose indicia”). Substrates comprising such multi-purpose indicia may or may not additionally incorporate a separate/additional Braille language indicia located proximate to the multi-purpose indicia. FIG. 10C illustrates enlarged views of printed substrates in the form of separate elements shown as printed substrate placards in the form of forward printed substrate region placard 79a and aft printed substrate region placard 79b that can be configured to occupy, for example, selected regions of a monument wall of the type shown in FIG. 7.

As shown in FIG. 10C the forward printed substrate region and the placard 79a and the aft printed substrate region placard 79b shown FIG. 10C each comprise printed visually detectable indicia 72 and printed tactilely detectable indicia 74, and with the visually detectable indicia printed onto the printed substrate to form raised indicia that is both visually detectable and tactilely detectable. That is, according to a present aspect, the visually detectable indicia 72 are also “raised” or built-up through additive manufacturing and depositing print material to the substrate surface.

The raised indicia shown in FIG. 10C are configured to convey both visual and tactile information from the same indicia to a passenger, and with the printed visual and tactile information imparted and printed onto the placard including destination-identifying information designed to identify a location in an aircraft cabin and convey information/messaging to, including directional information, to “guide” and/or “direct” a passenger from the detected information at the monument location to a selected destination and/or selected location that is located a distance away from (e.g., located remotely from), and in the direction indicated by, the location of the directional information/messaging. Although the placards 79a and 79b shown in FIG. 10C also comprise additional tactilely detectable indicia in the form of Braille language (that may not be visually detectable), the presence of Braille language on placards 79a, 79b as shown in FIG. 10C may not be present, as the sufficiently “raised” diagrams and directional arrows (“raised” from a printed substrate surface to, for example, a tactilely detectable indicia height ranging from about 20 mils to about 1000 mils from the printed substrate surface) serve both visual and tactile functions and can serve to direct both sighted and visually-challenged individuals without presenting the additionally provided Braille characters.

While the some of the printed substrate surfaces that are illustrated in the present FIGs. do not illustrate a design incorporated into the substrate surface (e.g., a “design” that can also be printed on the printed substrate, and/or a “design”, color, texture, that can be introduced to the substrate prior to supplying/printing the curable print material onto the substrate surface, etc.), present aspects contemplate the present printed substrates already comprising an aesthetically selected design on the substrate material then being supplied to a 3D printer for indicia printing, with the design already present in place on the substrate surface before the additively manufactured, raised, and printed indicia is formed on the substrate surface.

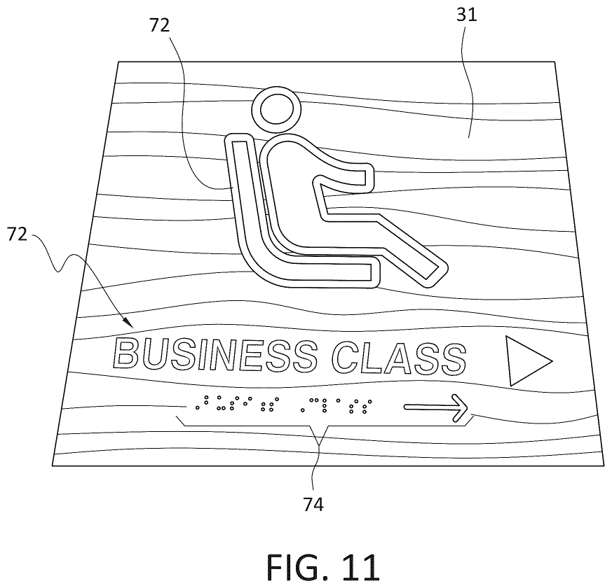

FIG. 11 shows another printed substrate that, according to present aspects, can be in the form of a placard having the visually detectable indicia 72 and the tactilely detectable indicia 74 described herein, and with the printed substrate also including a “background design” or “aesthetic “design”, and referred to equivalently herein as the substrate surface design 31 present on the substrate surface.

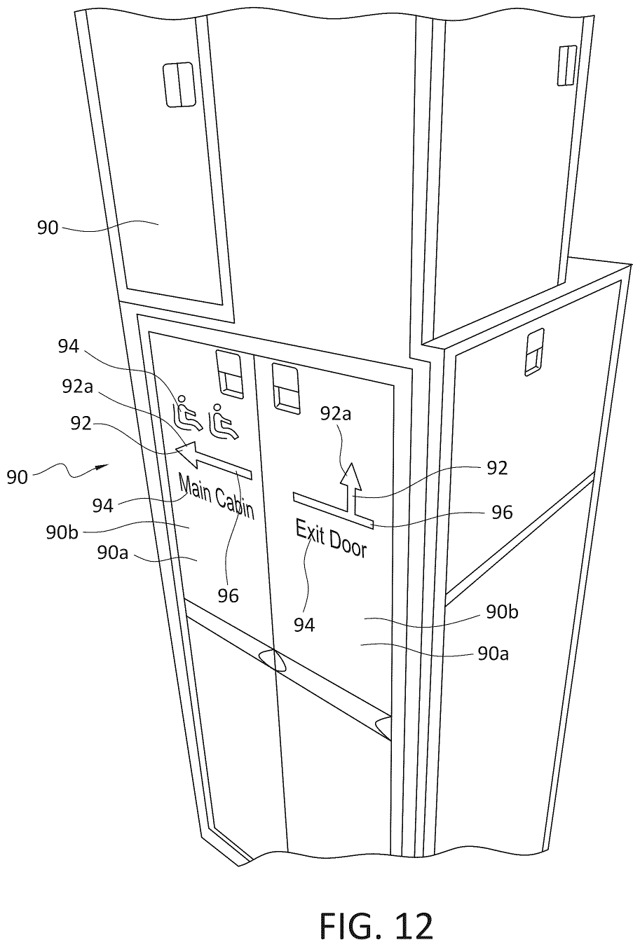

According to another present example, a tactilely detectable indicia is printed onto a substrate surface to form a printed substrate that is configured to form, for example, a printed substrate surface of a panel that can be an aircraft passenger cabin interior panel. In this present example, the printed substrate comprises a printed indicia pattern that is a printed tactilely detectable “wayfinding indicia”. As used herein, the term “wayfinding indicia” connotes a tactilely detectable indicia that conveys directional information to a user that tactilely contacts the wayfinding indicia. The wayfinding indicia can be a universally accepted directional indicia. The directional information conveyed to a recipient of the information imparts to the recipient information regarding an indicated (e.g., a “desired” and/or a “defined”) instructed passenger directional movement from the location of the wayfinding indicia toward another indicated/directed location. That is, the wayfinding indicia can impart tactilely-received information to a user, with the printed tactilely detectable wayfinding information configured to direct a user's movement in a direction toward or away from, for example, the location of a monument, the location of an exit, the location of an emergency exit, the location of a passenger class, etc. In one present example, the present wayfinding indicia can be a universally recognized symbol (e.g., an “arrow”, etc.), as shown, for example, in FIG. 12.

FIG. 12 shows a monument 90 that can be, for example, an aircraft passenger cabin monument that can be, for example, a storage closet. Monument 90 comprises a printed substrate 90a comprising a printed substrate surface 90b that has been printed upon according to present aspects to form a printed tactilely detectable indicia 92 and a printed visually detectable indicia 94. As shown in FIG. 12, the printed tactilely detectable indicia can also be printed to be visually detectable (as, e.g., an “arrow”) and can also serve as a printed visually detectable indicia. That is, according to present aspects, the wayfinding indicia can be printed onto the substrate to form a printed substrate surface where the print material is visible to a sighted individual and is also “raised” to be tactilely detectable by a sight-challenged user to form a “multi-purpose wayfinding indicia” 96 (e.g., the identical wayfinding indicia such as an “arrow” is printed to be both visually detectable and tactilely detectable).

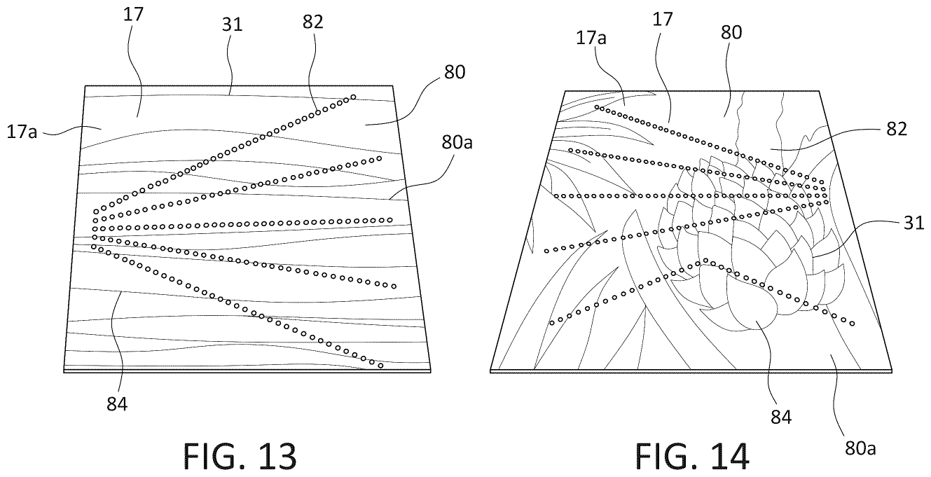

In another present example, the wayfinding indicia can be a collection of printed tactilely detectable indicia positioned to form, for example, a collection of immediately juxtaposed printed tactilely detectable indicia that, taken together in a collective perceived positioning, can be tactilely perceived to progressively and comparatively “ascend” relative to one another, and/or progressively and comparatively “descend” relative to one another. In one example, as shown in FIGS. 13 and 14, a plurality of tactilely detectable indicia are printed to form a plurality of “lines” that “descend” or “ascend” to a common area of convergence of the lines, and that convey to a tactile user a directional “command”; such that the user should move (e.g., the tactile user is being “instructed” to move) in the direction of the convergence of the lines.

FIGS. 13 and 14 illustrate printed substrates, according to present aspects where a tactilely detectable wayfinding indicia 82 (referred to equivalently herein as the “wayfinding indicia”) comprises a print material that has been deposited (e.g., “printed”) onto a substrate surface 17a of a substrate 17 to form a printed substrate 80, and then cured. As shown in FIGS. 13 and 14, the printed substrate comprises a printed substrate first side 80a comprising a substrate surface design 31. According to present aspects, the cured print material can be a transparent material and/or can be printed to match and/or to otherwise blend into a substrate surface design (e.g., a substrate surface “motif”, pantone color, etc.). That is, the printed tactilely detectable wayfinding indicia 82 can be printed onto the substrate surface, with the tactilely detectable wayfinding indicia 82 formed by the printed material being substantially visually undetectable and/or minimally visually detectable, and with at least a portion of the wayfinding indicia 82 being tactilely detectable while also being substantially visually undetectable and/or substantially visually unobtrusive.

In another present aspect, the visual design can be printed onto the substrate surface 17a of the substrate 17 and can also be printed to form a printed design that is a visually detectable printed design 84. FIG. 13 shows a printed visually detectable substrate surface design 31 that can be a background motif design. FIG. 14 shows a printed visually detectable substrate surface design 31 that can be a floral design.

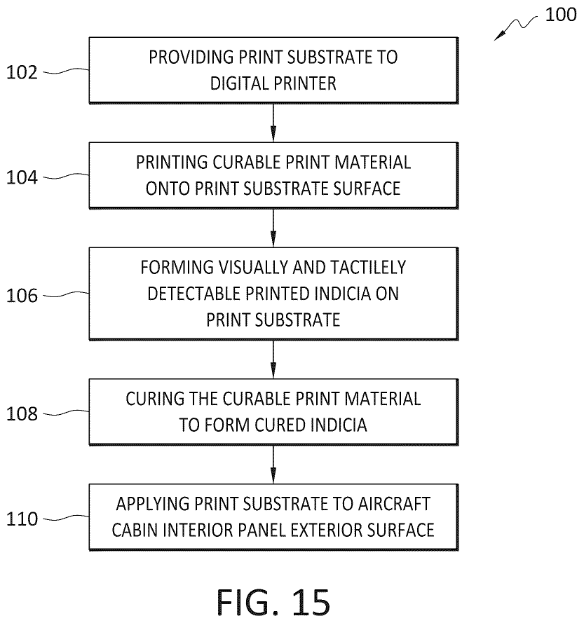

FIGS. 15, 16, 17, 18, 19, 20, 21, 22, 23, 24, and 25 are flowcharts outlining presently disclosed methods for forming the presently disclosed printed substrates comprising the printed visually detectable indicia and the printed tactilely detectable indicia. As shown in FIG. 15, a present aspect is directed to a method 100 for forming a combination of visually detectable printed indicia and tactilely detectable printed indicia onto an aircraft cabin interior panel exterior surface, with the method 100 comprising providing 102 a print substrate to a digital printer, with the print substrate comprising a print substrate surface, printing 104 a curable print material onto the print substrate surface, and forming 106 (e.g., with the curable print material configured to form) a combination of a curable visually detectable printed indicia and a curable tactilely detectable printed indicia on the substrate surface. The method further comprises curing 108 the print material to form a combination of a cured visually detectable printed indicia and a cured tactilely detectable printed indicia on the print substrate surface, and applying 110 or otherwise incorporating the printed substrate to and/or into the aircraft cabin interior panel exterior surface of an aircraft cabin interior panel, and wherein the printed substrate surface comprises the combination of visually detectable printed indicia and tactilely detectable printed indicia.

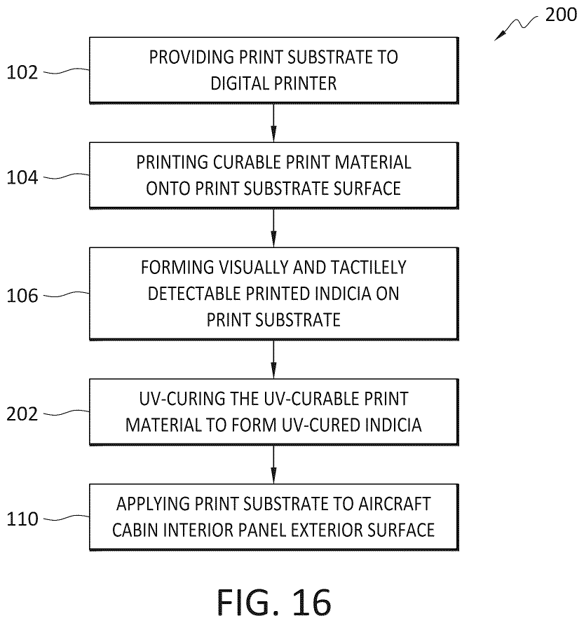

As shown in FIG. 16, in another present aspect, a method 200 comprises a number of the steps of method 100 and further comprises UV-curing 202 the curable print material to form the combination of the cured visually detectable printed indicia and the cured tactilely detectable printed indicia on the printed substrate surface.

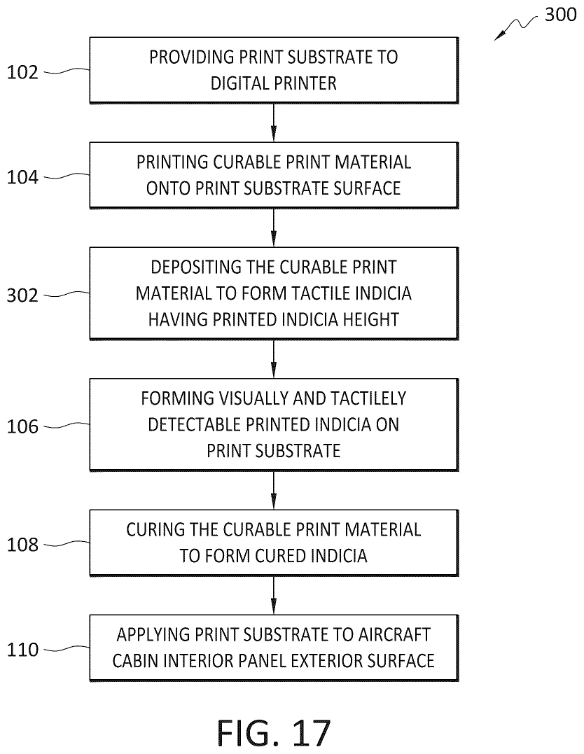

As shown in FIG. 17, in another present aspect, a method 300 comprises a number of the steps of method 100 and further comprises depositing 302 the curable print material onto the print substrate surface to a form the curable tactilely detectable printed indicia having an indicia height measured from the printed substrate surface with, in one present example, the printed indicia height ranging from about 20 mils to about 1000 mils.

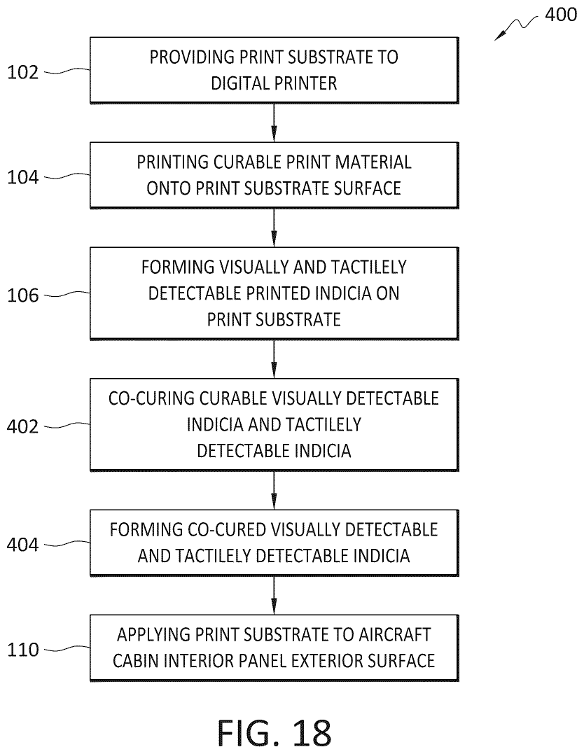

As shown in FIG. 18, in another present aspect, a method 400 comprises ta number of the step of method 100 and further comprises co-curing 402 the combination of the curable visually detectable printed indicia and the curable tactilely detectable printed indicia on the print substrate surface, and forming 404 a co-cured visually detectable printed indicia and a co-cured tactilely detectable printed indicia on the print substrate surface.

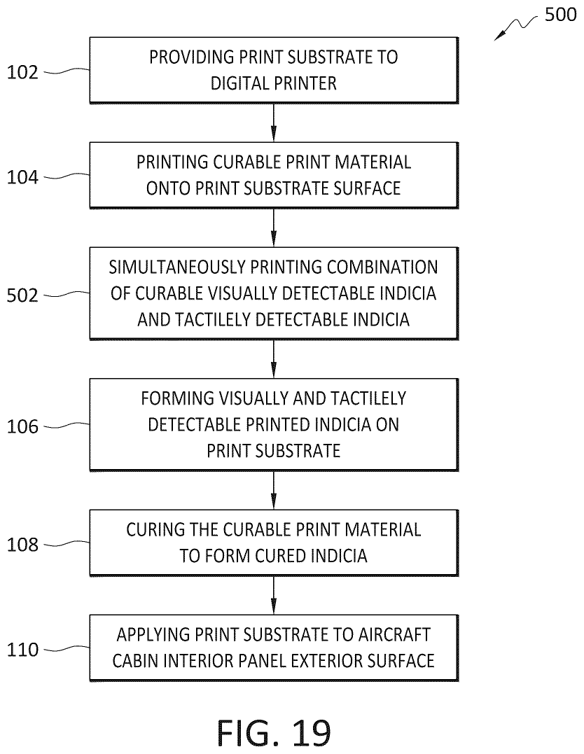

As shown in FIG. 19, in another present aspect, a method 500 comprises a number of the steps of method 100 and further comprises simultaneously printing 502 the combination of the curable visually detectable printed indicia and the curable tactilely detectable printed indicia onto the printed substrate surface.

The presently disclosed printed substrates comprising the printed visually detectable indicia and the printed tactilely detectable indicia shown in at least one or more of FIGS. 2, 3, 4, 5, 6, 7, 8, 9, 10A, 10B, 10C, 11, and 12 can be made according to one or more of the methods shown in at least FIGS. 15, 16, 17, 18, and 19.

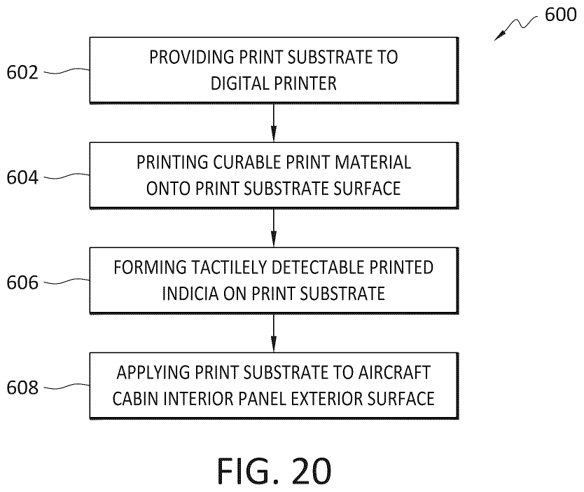

As shown in FIG. 20, another present aspect is directed to a method 600 for forming a tactilely detectable indicia onto an aircraft cabin interior panel, with the method comprising providing 602 a print substrate to a digital printer, with the print substrate comprising a print substrate surface, printing 604 curable print material onto the print substrate surface, with the print material forming 606 (e.g., with the curable print material configured to form) a tactilely detectable printed indicia on the print substrate surface, and applying 608 or otherwise incorporating the print substrate to an aircraft cabin interior panel exterior surface, and wherein the tactilely detectable printed indicia is configured to impart directional information to a passenger contacting the aircraft cabin interior panel exterior surface.

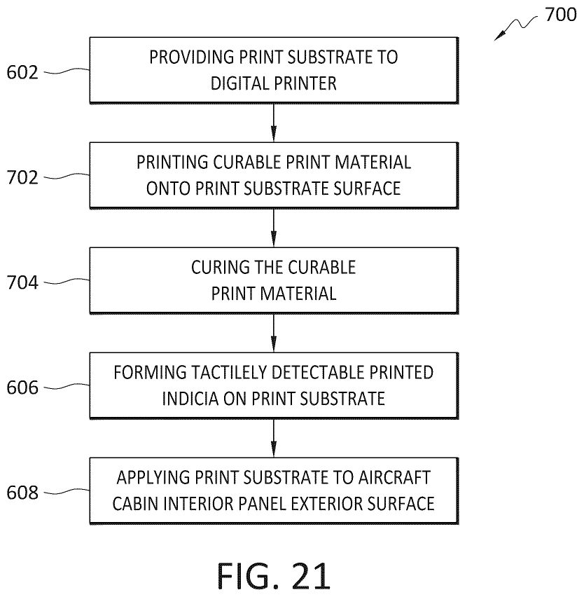

As shown in FIG. 21, in another present aspect, a method 700 comprises a number of the steps of method 600 and further comprises printing 702 a curable print material onto the print substrate surface, with the curable print material configured to form a curable tactilely detectable printed indicia on the print substrate surface, and curing 704 the curable print material to form a cured tactilely detectable printed indicia on the print substrate surface.

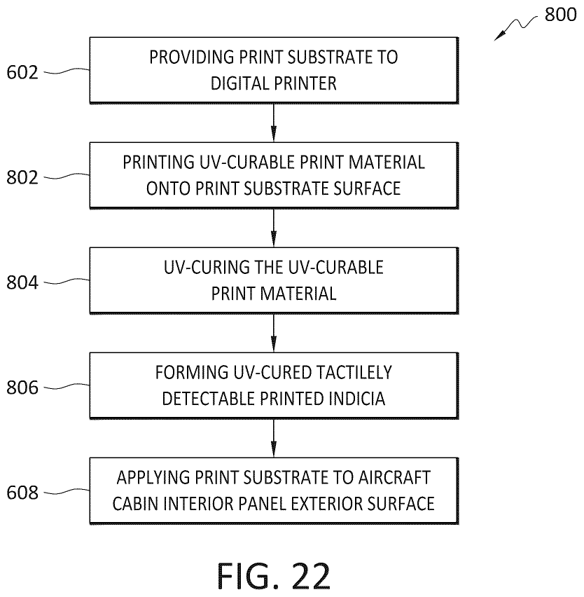

As shown in FIG. 22, in another present aspect, method 800 comprises a number of the steps of methods 600, 700 and further comprises UV-curing 802 the curable print material, and forming 804 the cured tactilely detectable printed indicia on the print substrate surface.

The presently disclosed printed substrates comprising the visually and tactilely detectable indicia shown in at least one or more of FIGS. 12, 13, 14 can be made according to one or more of the methods shown at least in FIGS. 20, 21, 22.

As mentioned herein, the visually detectable and the tactilely detectable indicia can be printed onto a substrate to form a printed substrate, where both indicia types (e.g., the visually detectable and the tactilely detectable indicia are printed onto the substrate surface to occupy the same printed substrate surface area, and the two indicia types at least partially and/or completely overlapping one another in the same printed substrate surface area.

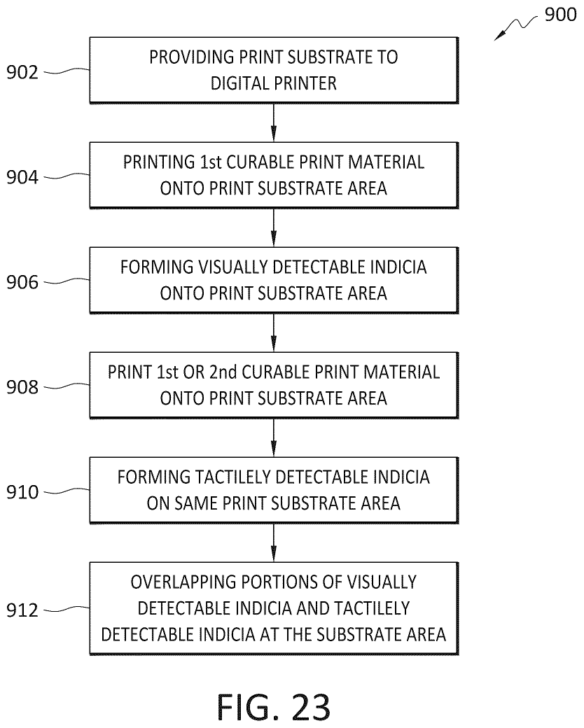

FIG. 23 shows a present aspect directed to a method for forming a combination of printed visually detectable printed indicia and printed tactilely detectable indicia onto an aircraft cabin interior panel exterior surface. As shown in FIG. 23, method 900 comprises providing 902 a print substrate to a digital printer, with the print substrate comprising a print substrate surface, printing 904 a first curable print material onto an area of the print substrate surface, and forming 906 (e.g., with the curable print material configured to form) a visually detectable printed indicia on a print substrate surface area. The method further comprises printing 908 at least one of the first curable print material and a second curable print material onto an area of the print substrate surface, and forming 910 (e.g., with the at least one of first and second curable print material configured to form) a tactilely detectable printed indicia on the print substrate surface area, and overlapping 912 at least a portion of the visually detectable printed indicia with the tactilely detectable printed indicia.

In another present aspect, the first curable print material is the same as the second curable print material.

In another present aspect, the first curable print material is different from the second print material.

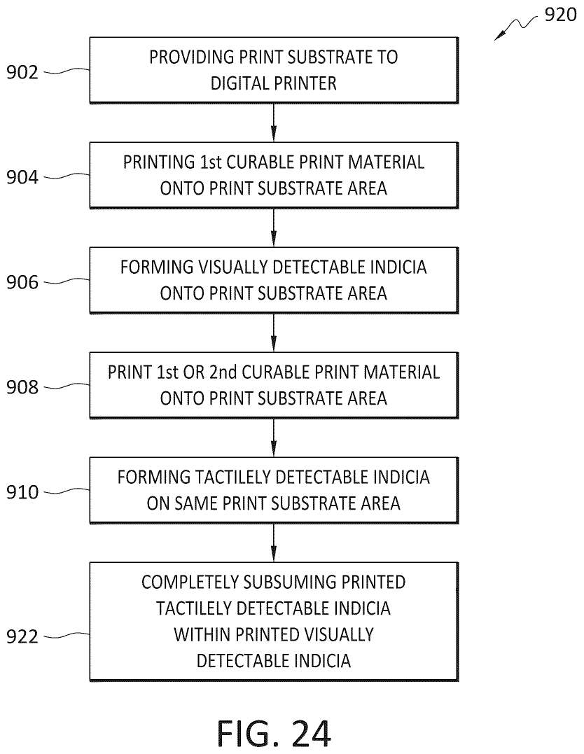

FIG. 24 shows a present aspect directed to a method 920 comprising a number of the steps of method 900 shown in FIG. 24, and further comprising (as compared to method 900 shown in FIG. 23) completely subsuming 922 the printed tactilely detectable indicia within the substrate surface area comprising the printed visually detectable indicia (e.g., achieving a complete “overlapping” of the two indicia types).

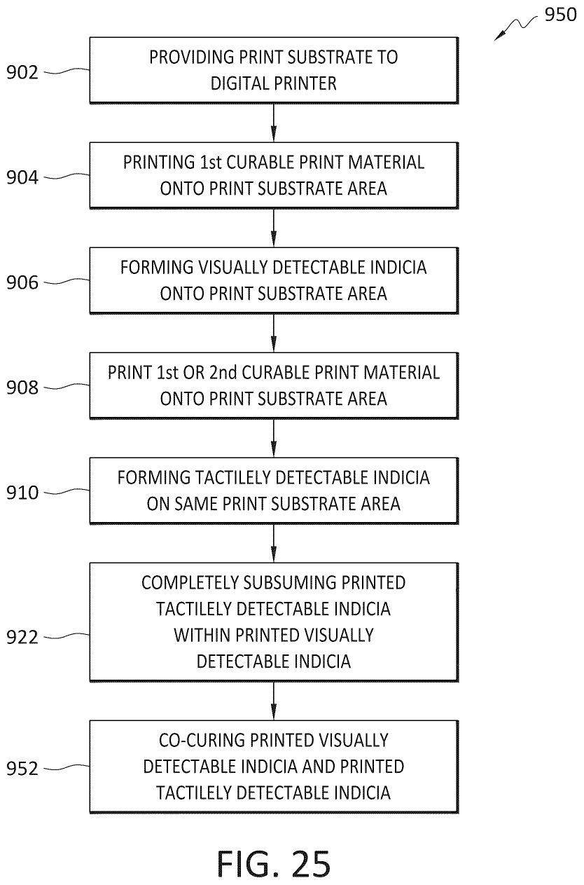

FIG. 25 shows a present aspect directed to a method 950 comprising a number of the steps of method 920 shown in FIG. 24, and further comprising, co-curing 952 the printed visually detectable indicia and the printed tactilely detectable indicia.

The presently disclosed printed substrates comprising the at least partially overlapping printed visually detectable indicia and the tactilely detectable indicia shown in one or more of FIGS. 10B and 10C, can be made according to at least one or more of the methods 900, 920, 950 and shown at least in FIGS. 23, 24, 25.

According to presently disclosed aspects, methods for forming the present printed substrate surfaces can include additive manufacturing steps and processes to include a graphic content for a decorative panel, converting graphics for printing with a raster image processor (RIP), and preparation of substrates or parts for 3D printing. The prepared substrates and substrate surfaces to be printed upon can then be printed using one or more of an array of UV-LED inkjet printers with the processed images printed upon the substrate surfaces of the substrates, imparting significant advantages in providing custom printed visually detectable indicia and textures and custom printed tactilely detectable indicia and textures onto durable surfaces that are aligned to custom graphics in a significantly simplified process.

The present printed substrates (e.g., that can be UV-curable inkjet ink printed surfaces) can be incorporated into aircraft passenger cabin structures (referred to equivalently herein as cabin components, cabin parts) by, for example, roll-to-roll or flatbed printing on thin film substrates and/or thin rigid substrates that can be adhesively bonded or mechanically affixed or otherwise secured to cabin structures including, for example, lavatory walls or other structure exterior surfaces (e.g., surfaces facing into a passenger cabin, etc.).

The presently disclosed decorative laminates and decorative interior lining and substrate surfaces can be fabricated, according to present methods, with comparatively higher print quality, greater color saturation, greater low to high-gloss surface quality within the same print area as compared to currently available cabin interior decorative substrates. In addition, custom surface textures can be printed up to selected thicknesses of print material that satisfies fire safety regulations while also achieving perfect agreement and/or registration of texture concepts combined with color and/or imagery concepts. For example, physical grooves in a printed wood panel can be produced to have consistent color changes at those grooves, making the substrate surface appear to be “real” wood.

The present processes used to impart the visually detectable and tactilely detectable printed indicia provide superior, more efficient, more material conserving, more-cost-effective manufacturing as compared to previous methods of making and modifying decorative and functional aircraft cabin surfaces that have formerly included multiple separate operations including but not limited to screen printing, laminating, sheeting, embossing, etc. By using direct 3-D additively manufactured printing onto a substrate surface, the surface can be applied to a previously fabricated portion of a decorative laminate, to a panel, or to the structural surface itself of a structure within an aircraft cabin. According to present aspects, the printed substrates in the form of decorative laminates, placards, etc., in present examples, can be applied, removed, and reapplied as the presently printed signage can be usable across different and/or changing aircraft design platforms and cabin configurations. In addition, the presently printed substrates can facilitate substrate surface rework, as high-quality substrate surface printed signage can be peeled, repaired, reapplied, etc., without damage to substrate surfaces.

Further advantages provided by the present aspects include a wide range of size availability by the described processes. Panels can be fabricated in small sizes from about 144 square inches to extra-wide panels where a splice in the decorative laminate liner would have normally been required. In one present example, substrate size for printing can include a substrate side of about 98 by 120 inches. In one present example, substrate size for printing can include a substrate size of about 80 by 120 inches. However the state substrate size dimensions can be larger.

As mentioned herein, the fabrication processes described herein can be used to produce aircraft cabin class dividers, walls of monuments, such as closets or crew rests, lavatory walls, doors, and backsplashes, and walls of first class and business class mini-suites, for example. The present printed substrates can be odorless, have low brittleness, have increased flexibility, can resist flaking during useful life in service, etc., while meeting design considerations, including long term UV stability, and fire safety regulations. Other present advantages for the disclosed printed substrates include improved resistance to, for example:
abrasion; scratches; scrapes; impact; puncture; humidity damage; fungus; cleaning products and solvents; staining from use; staining from passenger contact, etc. Additional benefits of the manufactured printed substrates and processes disclosed herein include, for example: providing a simplified production process with; less waste produced; expanded signage and messaging capability across multi-sensory messaging platforms (e.g., tactilely and visually detectable); lower-cost for equipment, tooling; improved customization for messaging and branding capability messaging); inventory and storage elimination, etc.

The term “substantially” as used herein means that a particular physical element, physical positioning, physical shape, orientation, etc., is almost completely or is nearly achieved. That is, for example, according to present aspects, a “substantially” transparent material means a material that almost completely and/or nearly completely transparent. In addition, a “substantially” visually undetectable and/or visually indistinct tactilely detectable indicia means a tactilely detectable indicia that is unobtrusive and that is almost completely and/or nearly completely visually undetectable. In addition, a “substantially” equivalent message is meant to include a nearly and/or almost entirely and completely equivalent message. In addition, a “substantially” simultaneous event in terms of timing (e.g., printing, etc.) means that two operations are occurring at the same time and can start and or finish at almost the identical time duration. In addition, with respect to relative/comparative spatial and/or oriented positioning, the term “substantially” perpendicular, for example, means that two structures are placed at nearly 90 degree angles to one another.

The present aspects may, of course, be carried out in other ways than those specifically set forth herein without departing from essential characteristics of the present disclosure. The present aspects are to be considered in all respects as illustrative and not restrictive, and all changes coming within the meaning and equivalency range of the appended claims and are intended to be embraced therein.

What is claimed:

1. A substrate comprising a cured print material printed onto the substrate to form a printed substrate, said printed substrate comprising:
a printed substrate first side comprising a combination of visually detectable printed indicia and tactilely detectable printed indicia, said printed substrate first side further comprising a printed substrate first side printing area and further comprising a printed substrate first side surface; and
a printed substrate second side;
wherein the substrate comprises a substrate thickness ranging from about 5 mils to about 1000 mils; and
wherein the tactilely detectable printed indicia comprises a cured print material, said cured print material deposited onto the printed substrate first side to a height measured from the printed substrate first side surface ranging from about 20 mils to about 1000 mils.

2. The substrate of claim 1, wherein the substrate is substantially transparent.

3. The substrate of claim 1, wherein the tactilely detectable printed indicia is substantially transparent.

4. The substrate of claim 1, wherein the tactilely detectable printed indicia comprises a plurality of Braille language characters.

5. The substrate of claim 4, wherein the visually detectable printed indicia is configured to convey a visually detectable message to a viewer, said tactilely detectable printed indicia configured to convey a Braille language message, said Braille language message being equivalent to the visually detectable message.

6. The substrate of claim 1, further comprising an adhesive layer immediately adjacent to substrate second surface.

7. The substrate of claim 6, wherein the adhesive layer is substantially transparent.

8. The substrate of claim 1, wherein the substrate is a decorative laminate material.

9. The substrate of claim 1, wherein the visually detectable indicia and the tactilely detectable indicia are both printed within the same printed substrate first side printing area.

10. The substrate of claim 9, wherein the printed visually detectable indicia at least partially overlaps the printed tactilely detectable indicia.

11. The substrate of claim 9, wherein the printed visually detectable indicia completely overlaps the printed tactilely detectable indicia.

12. An aircraft passenger cabin interior panel comprising the substrate of claim 1.

13. An aircraft passenger cabin comprising the substrate of claim 1.

14. An aircraft comprising the substrate of claim 1.

15. A method for forming a related combination of visually detectable printed indicia and tactilely detectable printed indicia onto an aircraft cabin interior panel exterior surface, the method comprising:
providing a substrate to a digital printer, said substrate comprising a substrate surface;
printing a curable print material onto the substrate surface to form a printed substrate comprising a printed substrate surface, said printed substrate surface comprising a plurality of substrate surface printing areas;
forming, on the substrate surface a combination of a curable visually detectable printed indicia and a curable tactilely detectable printed indicia;
curing the curable print material to form a combination of a cured visually detectable printed indicia and a cured tactilely detectable printed indicia on the printed substrate surface;
applying the printed substrate to the aircraft cabin interior panel exterior surface of an aircraft cabin interior panel; and
wherein the printed substrate surface comprises the combination of visually detectable printed indicia and tactilely detectable printed indicia.

16. The method of claim 15, the method further comprising:
UV-curing the curable print material to form the combination of the cured visually detectable printed indicia and the cured tactilely detectable printed indicia on the printed substrate surface.

17. The method of claim 15, the method further comprising:
depositing the curable print material onto the printed substrate surface to form the curable tactilely detectable printed indicia having a tactilely detectable printed indicia height measured from the print substrate surface, said tactilely detectable printed indicia height ranging from about 20 mils to about 1000 mils.

18. The method of claim 15, the method further comprising:
co-curing the combination of the curable visually detectable printed indicia and the curable tactilely detectable printed indicia on the print substrate surface; and
forming a co-cured visually detectable printed indicia and a co-cured tactilely detectable printed indicia on the printed substrate surface.

19. The method of claim 15, the method further comprising:
simultaneously printing the combination of the curable visually detectable printed indicia and the curable tactilely detectable printed indicia onto the printed substrate surface.

20. The method of claim 15, wherein the curable visually detectable printed indicia and the curable tactilely detectable printed indicia are printed within the same printed substrate surface printing area, said curable tactilely detectable printed indicia at least partially overlapping the curable visually detectable printed indicia.

21. The method of claim 20, wherein the curable visually detectable printed indicia completely overlaps the curable tactilely detectable printed indicia.
